(19) United States
(12) Patent Application Publication
(10) Pub. No.: US 2026/0038912 A1
(43) Pub. Date: Feb. 5, 2026

(54) Cold Plate With Multi Mini-Channels

(71) Applicant: LG Energy Solution, Ltd., Seoul (KR)

(72) Inventor: Hee Kook YANG, Sterling Heights, MI (US)

(73) Assignee: LG Energy Solution, Ltd., Seoul (KR)

(21) Appl. No.: 18/790,629

(22) Filed: Jul. 31, 2024

(51) Int. Cl. H01M 10/6556; H01M 10/613; H01M 10/6568; H01M 50/204

(52) U.S. Cl. CPC H01M 10/6556; H01M 10/613; H01M 10/6568; H01M 50/204

(57) ABSTRACT

A cold plate assembly includes a first plate having a first protruding manifold portion and a plurality of protruding cooling fluid passages that each extend from the first protruding manifold portion and include a first elongated portion extending directly from the first protruding manifold portion and connected to a second elongated portion. The second elongated portion includes a terminating end with a land region between the terminating end and the protruding manifold portion. A second plate is attached to an outer perimeter of the first plate and to the lands of the first plate. The second plate includes a plurality of apertures that each overlap with the terminating end of a respective one of the plurality of protruding cooling fluid passages. A manifold plate is secured to the second plate and defines a second protruding manifold portion that overlaps the plurality of apertures of the second plate.

### FIELD

Aspects of the present disclosure relate to a cold plate with multi mini-channels and related systems.

### BACKGROUND

This section provides background information related to the present disclosure which is not necessarily prior art.

The demand for electric vehicles and other electrical applications have greatly expanded the need for battery packs for energy storage. The battery packs can include a plurality of battery cells or battery modules that can include one or more battery cells. During the charging and discharging of battery packs the battery cells can give off heat. Accordingly, it is desirable to provide the battery packs with a thermal management system that can include a cold plate on which battery cells and/or modules are supported and that is liquid cooled. The cold plates have a coolant flow pattern that directs the liquid coolant throughout the cold plate.

Most of current cold plate flow patterns have difficulties to meet both important requirements of temperature balance and pressure drop. Temperature balance requires that the cold plate provide even cooling between all of the battery cells or modules. To achieve temperature balance, very long and winding flow patterns are required for all portions of the cold plate to have a similar average temperature between the inlet and outlet temperatures. The pressure drop of a cold plate is the amount the pressure differs from the inlet to the outlet of the cold plate. To achieve a low pressure drop, the complexity of the coolant passages is sacrificed so that the temperature gap at different locations along the cold plate usually gets larger among modules.

### SUMMARY

This section provides a general summary of the disclosure, and is not a comprehensive disclosure of its full scope or all of its features. Each of the examples disclosed herein may include one or more of the features described in connection with any of the other disclosed examples.

According to an aspect of the present disclosure, a cold plate assembly includes a first plate having a first protruding manifold portion and a plurality of protruding cooling fluid passages that each extend in parallel from the first protruding manifold portion and include a first elongated portion extending directly from the first protruding manifold portion to a U-turn bend region that connects a second elongated portion to the first elongated portion, the second elongated portion extends in parallel to the first elongated portion with a land region therebetween and the second elongated portion includes a terminating end with a land region between the terminating end and the first protruding manifold portion; a second plate attached to an outer perimeter of the first plate and to the lands of the first plate, the second plate includes a plurality of apertures therethrough that each overlap with the terminating end of a respective one of the plurality of protruding cooling fluid passages, wherein all but one of the second elongated portions are immediately adjacent to two of the first elongated portions on opposite sides; and a manifold plate secured to the second plate and defining a second protruding manifold portion that overlaps the plurality of apertures of the second plate.

According to a further aspect, the manifold plate includes an outlet port in communication with the second protruding manifold portion.

According to a further aspect, the manifold plate includes an inlet port that is in communication with the first protruding manifold portion through an aperture in the second plate.

According to a further aspect, the second protruding manifold portion is tapered so as to have a wider distal end that narrows toward the outlet port.

According to a further aspect, the manifold plate includes an inlet port in communication with the second protruding manifold portion.

According to a further aspect, the manifold plate includes an outlet port that is in communication with the first protruding manifold portion through an aperture in the second plate.

According to a further aspect, the first plate has a generally planar outer perimeter region that is connected to a first side of the second plate.

According to a further aspect, the manifold plate has a generally planar outer perimeter region that is connected toa second side of the second plate.

According to a further aspect, a thermal interface material is disposed on the second plate.

According to a further aspect, a plurality of battery cells are supported on the thermal interface material.

According to another aspect, a battery pack includes a cold plate assembly including a first plate having a first protruding manifold portion and a plurality of protruding cooling fluid passages that each extend in parallel from the first protruding manifold portion and include a first elongated portion extending directly from the first protruding manifold portion to a U-turn bend region that connects a second elongated portion to the first elongated portion. The second elongated portion extends in parallel to the first elongated portion with a land region therebetween and the second elongated portion includes a terminating end with a land region between the terminating end and the protruding manifold portion, wherein all but one of the second elongated portions are immediately adjacent to two of the first elongated portions on opposite sides. A second plate is attached to an outer perimeter of the first plate and to the lands of the first plate. The second plate includes a plurality of apertures therethrough that each overlap with the terminating end of a respective one of the plurality of protruding cooling fluid passages. A manifold plate is secured to the second plate and defines a second protruding manifold portion that overlaps the plurality of apertures of the second plate. A plurality of battery modules are supported by the cold plate assembly.

The present disclosure provides a cold plate design to achieve low pressure drop while maintaining temperature balance throughout the cold plate. In turn, the cold plate helps maintain temperature balance among objects in contact with the cold plate, e.g., battery modules. The cold plate has multiple mini flow patterns in one cold plate to maintain average temperature similar with a main inlet channel and outlet ends of the channels have holes connected to another outlet plate.

The cold plate includes three layers of plates including a first plate having multiple mini channels, a second plate attached to a thermal interface material, and a third outlet channel plate.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a battery cooling system having a cold plate assembly with a plurality of battery modules;

FIG. 2 is an exploded perspective view of the cold plate assembly according to the principles of the present disclosure;

FIG. 3 is a bottom perspective view of the cold plate assembly according to the principles of the present disclosure;

FIG. 4 is a top perspective view of the cold plate assembly according to the principles of the present disclosure;

FIG. 5 is a plan view of the bottom plate of the cold plate assembly according to the principles of the present disclosure;

FIG. 6 is a plan view of the outlet manifold plate according to the principles of the present disclosure; and

FIG. 7 is a cross-sectional view of a portion of the cold plate taken along line 7-7 of FIG. 3.

Corresponding reference numerals indicate corresponding parts throughout the several views of the drawings.

### DETAILED DESCRIPTION

Example embodiments will now be described more fully with reference to the accompanying drawings. Wherever possible, the same or similar reference numbers will be used throughout the drawings to refer to the same or like parts. Embodiments of the disclosure may solve one or more of the limitations in the art. The scope of the disclosure, however, is defined by the attached claims and not the ability to solve a specific problem.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this disclosure, relative terms, such as, for example, “about,” “substantially,” “generally,” and “approximately” are used to indicate a possible variation of ±10% in a stated value or characteristic.

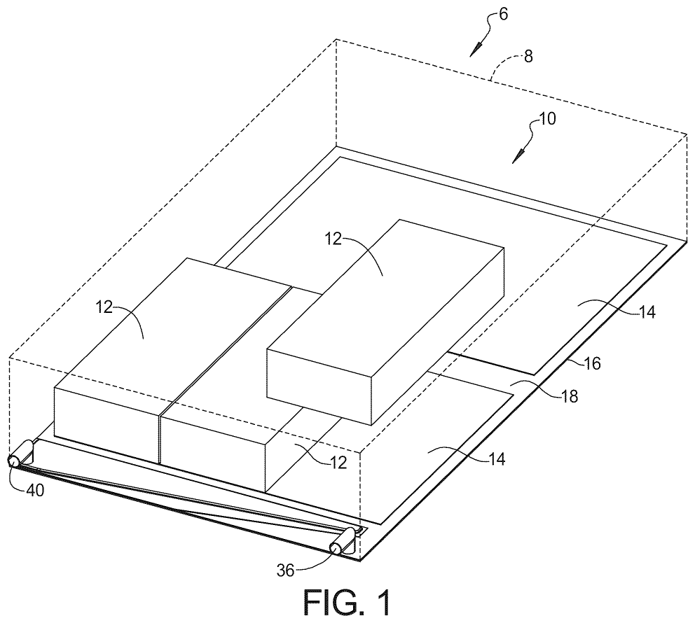

With reference to FIG. 1, a battery pack 6 is shown including a cold plate assembly 10 having a plurality of battery modules or battery cells (represented by the reference numeral 12) that are placed on the cold plate assembly 10 within the battery pack 6. The battery pack 6 can include a sidewall structure 8 that combines with the cold plate assembly 10 to define a housing. One or more cold plate assemblies 10 can be used in the battery pack 6. The number of battery cells or modules 12 can vary depending upon the application. In the case of the use of battery modules 12, the battery modules 12 may contain one or more battery cells e.g., a cylindrical cell, a pouch cell, a prismatic cell, and any other known battery cell types. Moreover, in some other embodiments, individual battery cells 12 may be in direct contact with cold plate assembly 10, without being housed within any module. The individual battery cells 12 can include cylindrical cells, pouch cells, prismatic cells and any other known battery cell types. The cold plate assembly 10 includes a bottom plate 16, an upper plate 18 and a manifold plate 20 as will be described in greater detail hereinbelow. The cold plate assembly 10 further includes an inlet port 40 and an outlet port 36 that are connected to the manifold plate and that provide fluid inlet and fluid outlet to coolant passages within the cold plate assembly 10 as will be described in further detail hereinbelow.

The cold plate assembly 10 can optionally be covered with a thermal interface material 14 that can be disposed between the cold plate assembly 10 and battery modules 12 for increasing the transfer of heat between battery modules or cells 12 and the cold plate assembly 10. Thermal interface materials 14 are generally known in the art for enhancing heat conduction between the battery modules/cells and the cold plate assembly 10. The thermal interface material 14 can include a ceramic filled polymer matrix (e.g. alumina filled silicone) and is usually a compressible, compliant gap pad that improves the surface contact to the battery modules or cells 12 by reducing the airgap therebetween. By reducing the airgap and providing greater surface contact, the thermal interface material 14 can ensure efficient heat dissipation from the battery modules or cells 12 to the cold plate assembly 10 to maintain consistent cell temperatures and prevent overheating. The thermal interface material 14 can optionally be adhered to the cold plate assembly 10.

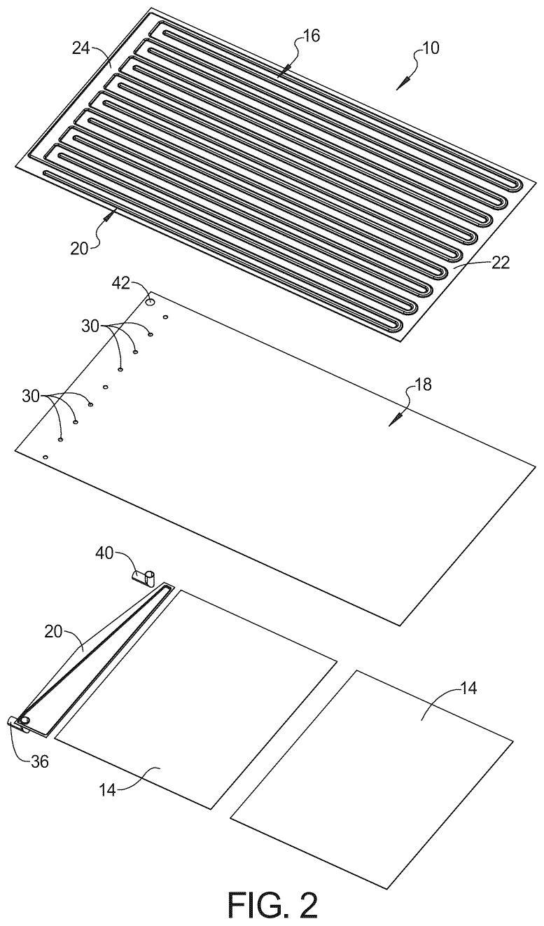

With reference to FIG. 2, an exploded perspective view of cold plate assembly 10 is shown including a bottom plate 16 and an upper plate 18 that is secured on top of the bottom plate 16. A manifold plate 20 is secured to a top of the upper plate 18. Each of the bottom plate 16, the upper plate 18 and the manifold plate 20 can be made from sheet metal including aluminum, steel or other heat conducting metal. The connection between the bottom plate 16, the upper plate 18 and the manifold plate 20 can be by welding, solder, clamping, adhesives or other known connection methods.

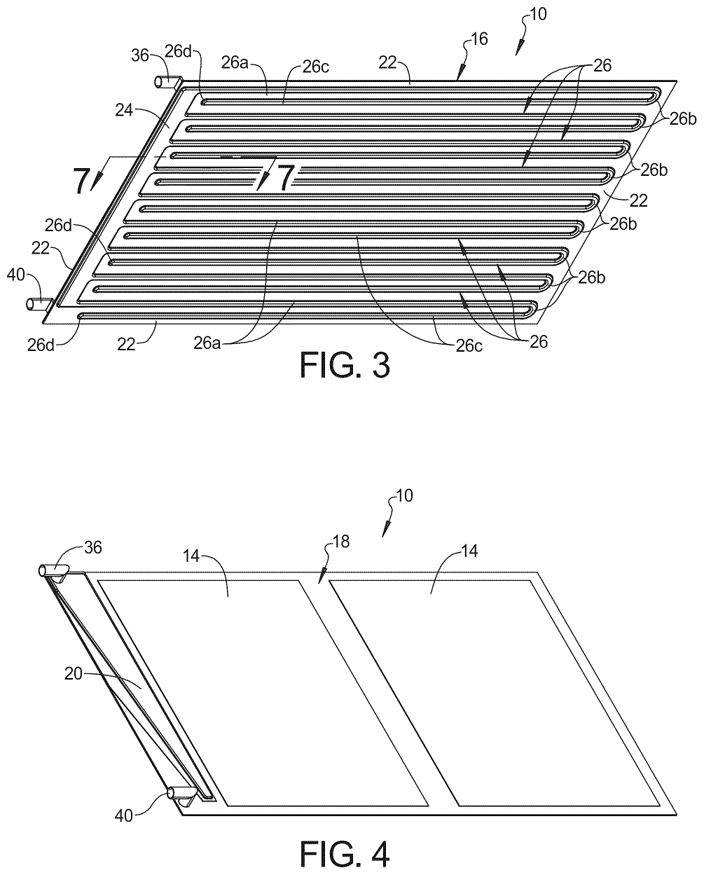

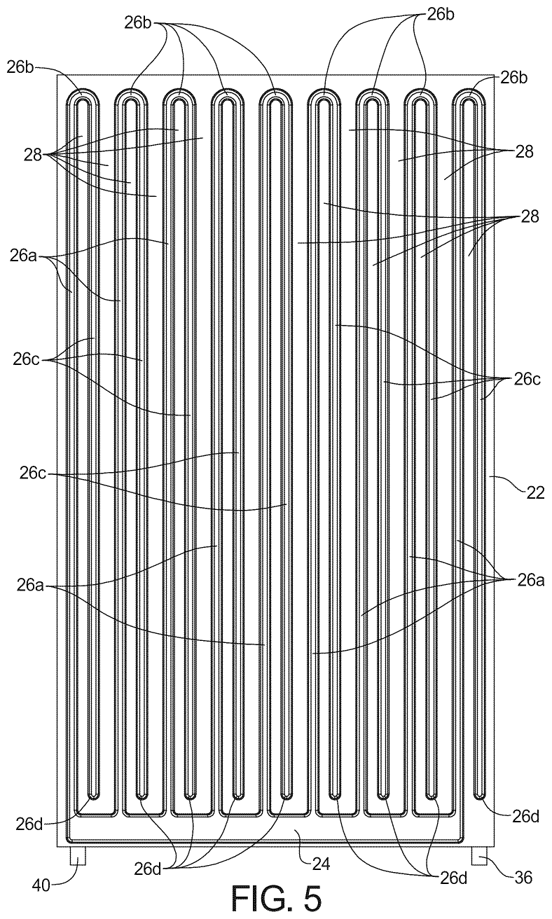

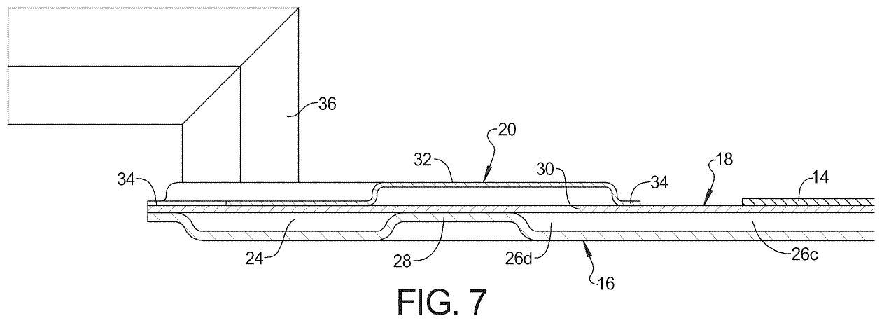

With reference to FIGS. 3 and 5, the bottom plate 16 is shown wherein the bottom plate 16 includes an outer perimeter region 22 that can be flat or generally planar. An elongated inlet manifold portion 24 can be stamped or otherwise formed into the bottom plate 16 such that it protrudes away from a plane of the outer perimeter region 22. The manifold portion 24 can extend partially across a majority of a width of the bottom plate 16. As best shown in the cross-sectional view of FIG. 7, the manifold portion 24 can include a sidewall 24a and a top wall 24b. The sidewall 24a extends from the outer perimeter region 22 and is connected to the top wall 24, as best shown in the cross-sectional view of FIG. 7. The top wall portion 24b can be generally flat and lie within a plane that is generally parallel to the outer perimeter region 22.

With continued reference to FIGS. 3 and 5, a plurality of cooling fluid passages 26 are also stamped or otherwise formed into the bottom plate 16 so as to protrude away from a plane of the outer perimeter region 22 in a same direction and manner as the manifold portion 24. The cooling fluid passages 26 each have a first elongated portion 26a extending directly from the inlet manifold portion 24 so that each first elongated portion 26a is in fluid communication with the elongated inlet manifold portion 24. The protruding cooling fluid passages 26 further include a U-turn bend region 26b that connects a second elongated return portion 26c to the first elongated portion 26a. The second elongated return portion 26c can be parallel to the first elongated portion 26a. As best shown in FIG. 5, the protruding cooling fluid passages 26 are each separated by and surrounded by a land portion 28 that is co-planar with the outer perimeter region 22. The land portion 28 extends between the first elongated portion 26a and the second elongated return portion 26b. The plurality of protruding cooling fluid passages 26 are arranged side-by-side adjacent to one another along a width of the bottom plate 16. The plurality of protruding cooling fluid passages 26 extend in parallel to one another and lengthwise of the bottom plate 16 from the inlet manifold portion 24 to the U-turn bend regions 26b thereof. The second elongated return portions 26c extend from the U-turn bend regions 26b and have a terminating end 26d that falls short of the inlet manifold portion 24 with lands 28 therebetween. The cooling fluid passages 26 are arranged so that all but one of the second elongated return portions 26c are immediately adjacent to two of the first elongated portions 26a on opposite sides thereof and likewise, all but one of the first elongated portions 26a are immediately adjacent to two of the second elongated return portions 26c on opposite sides thereof.

In the embodiment shown, nine cooling fluid passages 26 are shown. It should be understood however that more or fewer cooling fluid passages 26 can be used based upon the size of the cold plate assembly 10 and the cooling requirements of the battery pack 6. The length or the cooling fluid passages 26 are dependent upon the size of the cold plate assembly while providing a sufficient size of the outer perimeter region 22 for connecting to the upper plate 18. The cooling fluid passages 26 can have a width of between 8 mm to 15 mm.

With reference to FIG. 4, a perspective view of the cold plate assembly 10 is shown and includes a generally flat upper plate 18 with an outer perimeter that is generally equal in size and shape to the bottom plate 16. As shown in FIG. 2, the upper plate 18 includes a plurality of apertures 30 that each align with and is in fluid communication with a corresponding one of the terminating ends 26d of the elongated return portions 26c of the plurality of protruding cooling fluid passages 26. The upper plate 18 engages the planar outer perimeter region 22 and the intermediate lands 28 of the bottom plate 16 such that upper plate 18, apart from apertures 30, seal and close off the protruding cooling fluid passages 26. As best shown in the cross-sectional view of FIG. 7, the plurality of apertures 30 in the upper plate 18 allow the fluid passages for the protruding cooling fluid passages 26 to extend from the terminating ends 26d and continue through the upper plate 18.

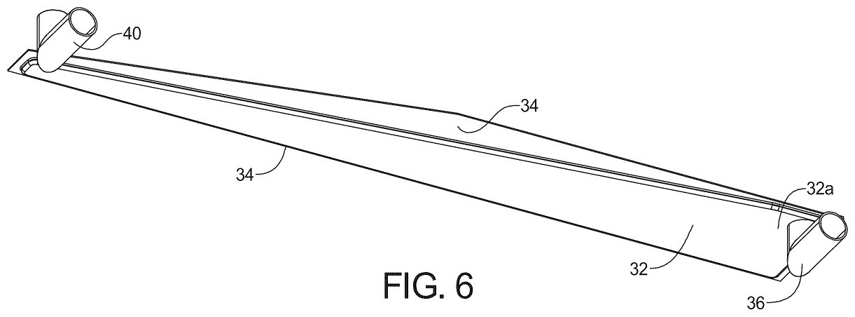

With continued reference to FIG. 7, the manifold plate 20 is secured to the upper plate 18 and defines an outlet manifold therebetween. With reference to FIG. 6, the manifold plate 20 includes a protruding manifold portion 32 that extends from a generally planar outer perimeter portion 34. The protruding manifold portion 32 covers all of the apertures 30 in the upper plate 18 and the generally planar outer perimeter portion is sealingly connected to the upper plate 18. The manifold plate 20 includes an outlet port 36 in communication with the protruding manifold portion 32. The protruding manifold portion 32 is tapered so as to have a wider firstnd 32a that narrows toward the other end. The manifold plate 20 can also include an inlet port 40 that may be in fluid communication with an aperture 42 in the upper plate 18 and into the inlet manifold portion 24 of the bottom plate 16. Alternatively, the inlet port 40 can be secured directly to the bottom plate 16 or the upper plate 18.

In operation, coolant fluid is supplied from a heat exchanger to the inlet port 40. The fluid then flows through the inlet manifold portion 24 to each of the plurality of parallel cooling fluid passages 26 and through the apertures 30 in the upper plate 18. From the apertures 30 in the upper plate, the fluid flows into and along the protruding manifold portion 32 of the manifold plate 20 and out of the outlet port 36.

With the cold plate design of the present disclosure, the pressure difference across the cold plate assembly 10 is maintained low because of the parallel flow through a large number of cooling fluid passages 26. As the fluid flows through the plurality of cooling fluid passages, heat is transferred to the cooling fluid. Accordingly, the temperature of the cooling fluid in the first elongated portion 26a is cooler than the cooling fluid in the second elongated return portions 26c. However, because the first elongated portions 26a are alternatively disposed between corresponding adjacent second elongated return portions 26c the heat transfer from the entirety of the cold plate assembly 10 is more evenly distributed and the temperature gap (i.e. the temperature variation along the cold plate assembly 10) is reduced. It is noted that the direction of flow of coolant through the cold plate assembly can be reversed without modification so that the manifold plate 20 defines the inlet manifold and the bottom plate 16 defines the outlet manifold.

The above description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cold plate assembly, comprising:
a first plate having a first protruding manifold portion and a plurality of protruding cooling fluid passages that each extend in parallel from the first protruding manifold portion and include a first elongated portion extending directly from the first protruding manifold portion to a U-turn bend region that connects a second elongated portion to the first elongated portion, the second elongated portion extends in parallel to the first elongated portion with a land region therebetween and the second elongated portion includes a terminating end with a land region between the terminating end and the first protruding manifold portion, wherein all but one of the second elongated portions are immediately adjacent to two of the first elongated portions on opposite sides;
a second plate attached to an outer perimeter of the first plate and to the lands of the first plate, the second plate includes a plurality of apertures therethrough that each overlap with the terminating end of a respective one of the plurality of protruding cooling fluid passages; and
a manifold plate secured to the second plate and defining a second protruding manifold portion that overlaps the plurality of apertures of the second plate.

2. The cold plate assembly according to claim 1, wherein the manifold plate includes an outlet port in communication with the second protruding manifold portion.

3. The cold plate assembly according to claim 2, wherein the manifold plate includes an inlet port that is in communication with the first protruding manifold portion through an aperture in the second plate.

4. The cold plate assembly according to claim 2, wherein the second protruding manifold portion is tapered so as to have a wider distal end that narrows toward another end.

5. The cold plate assembly according to claim 1, wherein the manifold plate includes an inlet port in communication with the second protruding manifold portion.

6. The cold plate assembly according to claim 5, wherein the manifold plate includes an outlet port that is in communication with the first protruding manifold portion through an aperture in the second plate.

7. The cold plate assembly according to claim 1, wherein the first plate has a flat outer perimeter region that is connected to a first side of the second plate.

8. The cold plate assembly according to claim 7, wherein the manifold plate has a generally planar outer perimeter region that is connected to a second side of the second plate.

9. The cold plate assembly according to claim 1, further comprising thermal interface material disposed on the second plate.

10. The cold plate assembly according to claim 9, further comprising a plurality of battery cells supported on the thermal interface material.

11. A battery pack, comprising:
a cold plate assembly including:
a first plate having a first protruding manifold portion and a plurality of protruding cooling fluid passages that each extend in parallel from the first protruding manifold portion and include a first elongated portion extending directly from the first protruding manifold portion to a U-turn bend region that connects a second elongated portion to the first elongated portion, the second elongated portion extends in parallel to the first elongated portion with a land region therebetween and the second elongated portion includes a terminating end with a land region between the terminating end and the first protruding manifold portion;
a second plate attached to an outer perimeter of the first plate and to the lands of the first plate, the second plate includes a plurality of apertures therethrough that each overlap with the terminating end of a respective one of the plurality of protruding cooling fluid passages, wherein all but one of the second elongated portions are immediately adjacent to two of the first elongated portions on opposite sides;
a manifold plate secured to the second plate and defining a second protruding manifold portion that overlaps the plurality of apertures of the second plate; and
a plurality of battery cells supported by the cold plate assembly.

12. The battery pack according to claim 11, wherein the manifold plate includes an outlet port in communication with the second protruding manifold portion.

13. The battery pack according to claim 12, wherein the manifold plate includes an inlet port that is in communication with the first protruding manifold portion through an aperture in the second plate.

14. The battery pack according to claim 12, wherein the second protruding manifold portion is tapered so as to have a wider distal end that narrows toward another end.

15. The battery pack according to claim 11, wherein the manifold plate includes an inlet port in communication with the second protruding manifold portion.

16. The cold plate assembly according to claim 15, wherein the manifold plate includes an outlet port that is in communication with the first protruding manifold portion through an aperture in the second plate.

17. The battery pack according to claim 11, wherein the first plate has a generally planar outer perimeter region that is connected to a first side of the second plate.

18. The battery pack according to claim 17, wherein the manifold plate has a generally planar outer perimeter region that is connected to a second side of the second plate.

19. The battery pack according to claim 11, further comprising thermal interface material disposed on the second plate and in contact with the plurality of battery cells.
